(19) United States
(12) Patent Application Publication
(10) Pub. No.: US 2006/0034351 A1
(43) Pub. Date: Feb. 16, 2006

(54) Monitoring stability of an on-frequency repeater

(75) Inventors: Colin Kellett, Kanata (CA); Mike Roper, Ottawa (CA); Shane Young, Nepean (CA); Jie Zhang, Kanata (CA)

Correspondence Address: OGILVY RENAULT LLP, 1981 MCGILL COLLEGE AVENUE, SUITE 1600, MONTREAL, QC, H3A2Y3, CA

(73) Assignee: SPOTWAVE WIRELESS INC., Ottawa (CA)

(21) Appl. No.: 10/917,385

(22) Filed: Aug. 13, 2004

(51) Int. Cl. H04B 1/707; H04L 25/52

(52) U.S. Cl. 375/147; 375/213

(57) ABSTRACT

In a system for monitoring stability of an on-frequency repeater, a wide-band signature (WBS) signal associated with the repeater is generated, and inserted into an output RF signal transmitted by the repeater. Signal components corresponding to the WBS signal in an input RF signal received by the repeater are detected and analyzed to estimate a feedback path loss L.

### CROSS-REFERENCE TO RELATED APPLICATIONS

This is the first application filed for the present invention.

### TECHNICAL FIELD

The present application relates to wireless access networks and, in particular, to a method and system for managing stability of an on-frequency repeater.

### BACKGROUND OF THE INVENTION

On-frequency repeaters are known in the art, for amplifying an input signal without otherwise altering its frequency spectrum. In some cases, an on-frequency repeater may also employ various types of active circuitry in order to enhance the signal-to-noise (S/N) ratio, in addition to simply increasing the power level. A typical application of on-frequency repeaters is for improving wireless services within defined regions of a wireless network, where signal levels would otherwise be too low for satisfactory quality of service. For example, within a building, or a built-up urban area, signal attenuation, shadowing by buildings and/or hills; noise generated by various radio frequency sources, and multi-path effects can seriously degrade the quality of desired RF signals. In some cases, a wireless network provider may install a repeater in order to improve service in a region lying at an edge of the coverage area serviced by a base station, thereby effectively extending the reach of the base-station.

On-frequency repeaters are characterized by the fact that input and output signals (in either the uplink or downlink path directions) have the same frequency. For the purposes of the present invention, the term “on-frequency repeater” shall be understood to refer to any amplifier system that has this characteristic, irrespective of whether the system is used as part of an wireless communications network, or in any other context. The external input signal received by the repeater (e.g. from a base station or a subscriber's wireless communications device) can be represented by:
Se=A·Cos(ωt+m(t)) (Equ.1)
Where A is the peak amplitude of the external input signal, ω is the carrier frequency and m(t) is the (frequency) modulation applied to the external input signal. In this case, the corresponding output signal radiated by the repeater can be represented by:
So=G·A·Cos(ω(t−δ)+m(t−δ)) (Equ.2)
Where G is the repeater gain and δ is the time delay through the repeater at the carrier frequency ω.

It will be seen that the output signal (So) radiated by the repeater is a replica of the input signal received by the repeater, that has been amplified and subject to a time delay δ due to electrical delays within the repeater. Part of this delay is inherent to the amplification process, but is primarily caused by band-pass filters used in the repeater to prevent the unwanted amplification of signals outside the frequency band of interest. Generally this delay is inversely proportional to the bandwidth of the filters. The repeater gain (G) provides the increase in signal level that makes the repeater useful.

A limitation of on-frequency repeaters is that the output signal (So) can feed back to the repeater input via a so-called “feedback path”. This feedback signal, which is present at the repeater's input antenna, is then:

$$Sf = ( \frac{G}{L} ) A \cdot Cos ( ω ( t - ( δ + Δ ) ) + m ( t - ( δ + Δ ) ) ) \qquad ( Equ . 3 )$$

Where L is the signal loss in the feedback path (that is, the antenna isolation), and Δ is the time delay in the feedback path at the carrier frequency ω.

It will be seen that, if the modulation rate is slow compared to

$$\frac{1}{( δ + Δ )} ,$$

the feedback signal appears as a phase-shifted version of the external input signal (Se). Consequently, as long as

$$( \frac{G}{L} ) < 1 ,$$

the resulting input signal (Si) received by the repeater will be the vector sum of the external input signal Se (Equ. 1) and the feedback signal Sf (Equ. 3). The magnitude of the input signal (Si) is a function of both the amplitude of the external input signal (Se) and the feedback signal Sf, and their relative phases. For a repeater system that employs automatic gain control, the magnitude of the output signal (So), and thus the feedback signal (Sf), will be held approximately constant over a wide range of input power. Such a system will remain stable when the feedback path isolation (L) is larger than the system gain (G).

However, if the system gain (G) becomes too high, so that L<G, then signal feedback between the output and input antennas will cause system oscillation. In principle, system stability can be obtained by ensuring that antenna isolation (L) is greater than the system gain (G). However, in practice, antenna isolation is difficult to predict, and will frequently change over time. Accordingly, on-frequency repeater gain is typically adjusted manually by a technician to be less than the expected antenna isolation by a significant margin in order to provide conditional stability in a changing RF environment. This margin significantly decreases the effectiveness of the repeater and yet does not prevent oscillation for all potential scenarios.

Various systems have been proposed for preventing oscillation in on-frequency repeaters.

For example, U.S. Pat. Nos. 5,125,108 and 5,584,065 disclose methods of removing interfering signals that are present along with desired communications signal traffic, using a sample of the interfering signal received by a separate, auxiliary antenna. In these references, adaptive techniques are employed to adjust the amplitude and phase of the sample so that, when it is combined with the output of the communication system's receiving antenna, the interfering signal is cancelled.

U.S. Pat. No. 4,475,243 describes an apparatus for minimizing the “spillover” signal from the transmitter to the receiver in a repeater. In this reference, the received signal is translated to baseband (i.e., the carrier is removed) for amplification (regeneration), then translated back up to the same carrier frequency (i.e., remodulating a carrier) for retransmission. An “injection signal” based on sampling the regenerated communication signal is used in conjunction with mixing and correlation techniques to isolate the spillover component of the input signal so that it can be removed at an intermediate frequency (IF) stage of the receiver. This system is designed to handle a single communication signal with narrowband analog voice modulation, and thus is not suitable for use with broadband signal traffic carrying multiple parallel communication signals.

Furthermore, in U.S. Pat. Nos. 4,701,935 and 4,789,993, a digital microwave radio repeater is described in which the desired digital signal is a single signal and is regenerated (amplified) at baseband. In these references, the transmitter-to-receiver coupled interference component that appears at baseband is canceled by subtracting an estimated baseband interference signal. The estimated baseband interference signal is produced by means of an equalization technique implemented by transversal filters whose characteristics are adaptively determined.

U.S. Pat. No. 4,383,331 teaches a system in which a “tag”, in the form of one or more side-frequencies, is added to the output signal prior to its retransmission. The detection of the tag in a received input signal allows the power level of the feed back signal to be measured, and this information allows the repeater to subtract out the interference. In principle, this technique could be applied to monitor antenna isolation in a repeater operating in a broadband RF environment. However, it suffers the limitation that the tag must be located in a side-band (i.e., lying above or below the bandwidth of the desired communications signal traffic) in order to avoid interference corrupting the desired communications signal traffic and/or interfering with other network components. Because antenna isolation can vary strongly with frequency, measurements based on side-band “tags” can, at best, provide only an rough approximation of the antenna isolation at the frequencies of the desired communications signal traffic.

U.S. Pat. No. 5,835,848, teaches a repeater in which antenna isolation is determined using a calibration procedure that is executed during periods in which no communications traffic is present. The calibration procedure involves opening a switch to prevent transmission of signals received at the input antenna; transmitting a test (pilot) signal from the output antenna; and then detecting the signal power of the test signal received through the input antenna. With this scheme, the test signal can be transmitted at any desired frequency, so it is possible to measure antenna isolation, as a function of frequency, across the entire operating bandwidth of the communications traffic. However, in order to accomplish this, there must be no communications signal traffic during the calibration procedure. This necessarily requires interruption of the communications signal traffic, which is highly undesirable.

The systems of U.S. Pat. Nos. 4,383,331 and 5,835,848 suffer the further disadvantage that, in most cases, the power level of the received test (pilot or tag) signal will be very low, requiring highly sensitive detection circuitry to successfully monitor. However, this high sensitivity renders the detection circuit vulnerable to radio frequency interference (RFI) emitted by many common electronic devices and/or test signals transmitted by other repeaters. The presence of noise at the same frequency as the test signal can easily render the system incapable of accurately detecting antenna isolation, and in fact may disable-the repeater entirely.

Applicant's co-pending U.S. patent application Ser. No. 09/919,888 proposes a solution in which a unique bit-sequence is encoded as a signature signal that is transmitted through an output antenna as a low-level fade impressed on a broadband RF signal. Applicant's co-pending U.S. patent application Ser. No. 10/299,797 proposes an alternative solution in which the signature signal is provided as pulse train having a unique combination of pulse rate, frequency etc. In both cases, the signal received through the input antenna is correlated with the signature signal, and the degree of correlation used as an indirect indicator of system stability. Impressing the signature signal onto the broadband RF signal (i.e., the desired communications signal traffic) as a low-level fade allows the system stability to continuously monitored without interfering with the communications signal traffic of other devices within the network. The use of a unique signature signal (by means of a unique PN code or pulse signal parameters) ensures that the system can distinguish between noise (both random RFI and test and/or signature signals from other repeaters) and its own signature signal.

However, both of these solutions suffer a disadvantage that the signature signal is impressed on the broadband RF signal as a low-level fade (that is, amplitude and/or phase modulation). In order to prevent interference, the modulation power of the signature signal must be kept low, but this inherently limits the ability of the detector to accurately detect the signature signal received by the input antenna, particularly in high noise environment.

Accordingly, a method and system capable of reliably monitoring stability of an on-frequency repeater, at a moderate cost, remains highly desirable.

### SUMMARY OF THE INVENTION

An object of the present invention is to provide a method and system for monitoring stability of an on-frequency repeater.

Accordingly, an aspect of the present invention provides a method for monitoring stability of an on-frequency repeater, a wide-band signature (WBS) signal associated with the repeater is generated, and inserted into an output RF signal transmitted by the repeater. Signal components corresponding to the WBS signal in an input RF signal received by the repeater are detected and analyzed to estimate a feedback path loss L.

### BRIEF DESCRIPTION OF THE DRAWINGS

Further features and advantages of the present invention will become apparent from the following detailed description, taken in combination with the appended drawings, in which:

FIG. 1 is a schematic diagram of an on-frequency repeater in accordance with an embodiment of the present invention;

FIGS. 2a and 2b are a block diagrams illustrating respective embodiments of a Wide band gain controller (WBGC) usable in the embodiment of FIG. 1;

FIG. 3 is a block diagram schematically illustrating an m-stage linear feedback shift register usable as the code generator of FIGS. 2a and 2b ; and

FIG. 4 is a is a block diagram schematically illustrating principle elements of the detector of FIG. 2a.

It will be noted that throughout the appended drawings, like features are identified by like reference numerals.

### DETAILED DESCRIPTION OF PREFERRED EMBODIMENTS

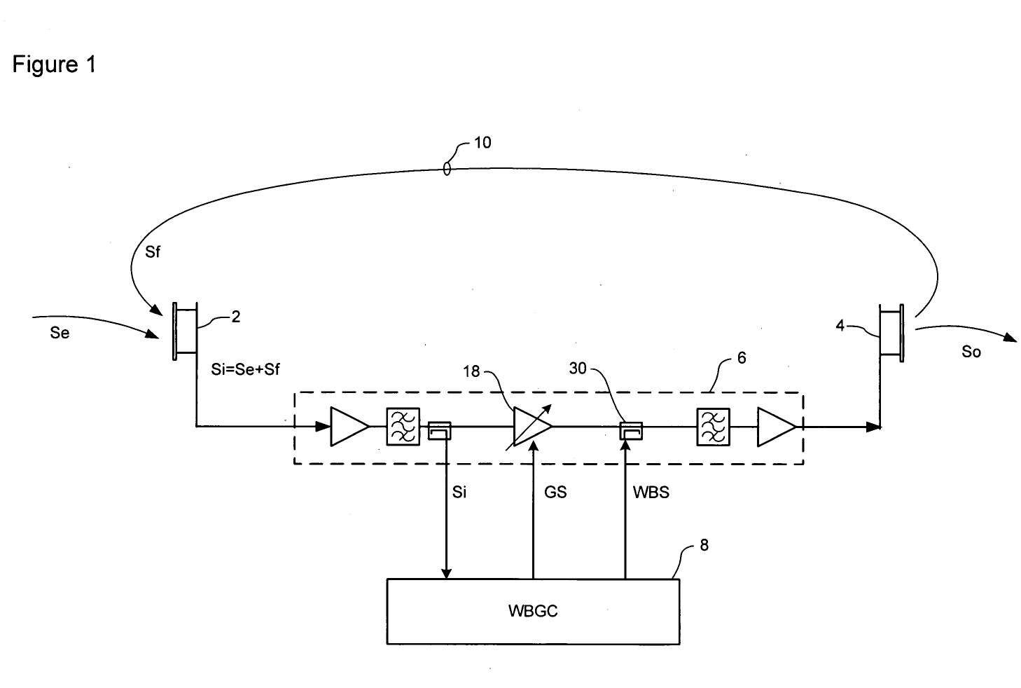

The present invention provides a method and system for monitoring stability of an on-frequency repeater. FIG. 1 is a block illustrating principle elements of a system in accordance with an embodiment of the present invention.

As shown in FIG. 1, a repeater includes an input antenna 2 for receiving an input signal (Si); an output antenna 4 for radiating an output signal (So) at the same frequency as the received input signal (Si); and a signal path 6 coupled between the input and output antennas in order to amplify the received input signal (Si) for retransmission as the output signal (So). In accordance with the present invention, stability of the signal path 6 is managed by the a Wide Band Gain Controller (WBGC) 8, as will be described in greater detail below.

FIG. 1 shows a single RF signal path 6 coupled between the input and output antennas 2 and 4. This arrangement will clearly be suitable for unidirectional RF signal traffic. Bi-directional signal traffic through the repeater can readily be accommodated by duplicating the system of FIG. 1, or by coupling a pair of signal paths between the two antennas via diplexers (not shown). Both of these solutions are well known in the art, and accordingly will not be described in greater detail. Similarly, the signal path 6 may include an Intermediate Frequency (IF) section (not shown) to facilitate filtering, amplification, and other signal processing functions, as is well known in the art.

In general, the bandwidth of the signal path 6 will be determined in accordance with the communications network within which the repeater will operate. For example, in North. America, publicly accessible cellular communications networks utilize a 25 MHz uplink and downlink channel bandwidth centered on 836.5 MHz and 881.5 MHz, respectively.

Because the radiated output signal (So) is an amplified (and phase shifted) replica of the received input signal (Si), a feedback signal (Sf) will couple between the output 4 and the input 2 via a feedback path 10, as described above and shown in FIG. 1. Thus the received input signal (Si) will be the vector sum of the external input signal (Se) and the feedback signal (Sf). As described above, if the isolation between the output antenna 4 and input antenna 2 is less than the total gain of the signal path 6, then (Sf) may become greater than (Se), and unstable operation of the repeater (in the form of oscillation) will occur.

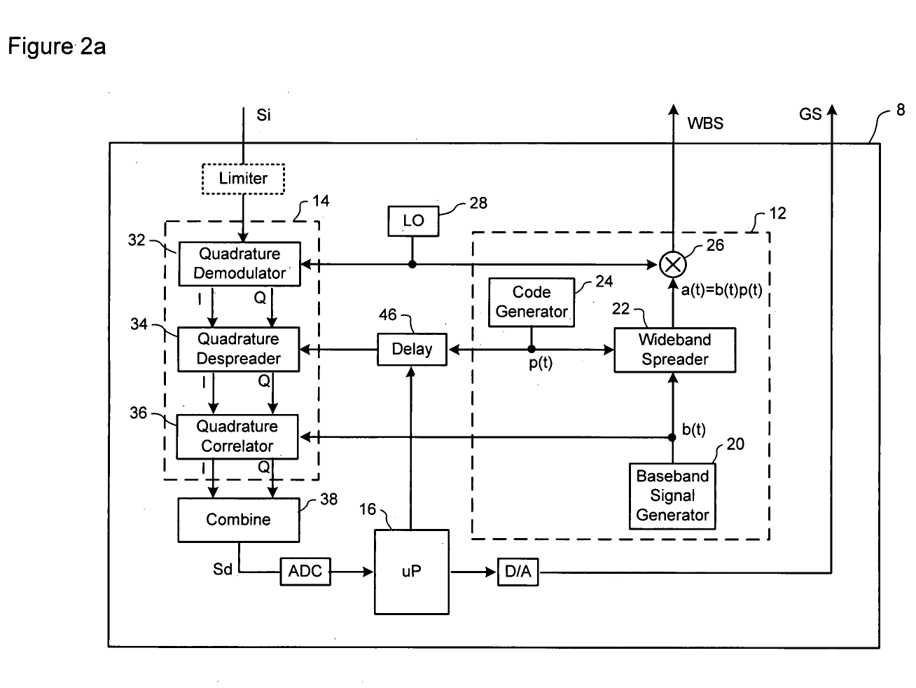

In general, the Wide Band Gain Controller (WBGC) 8 block of the present invention operates by adding a wide-band signature (WBS) signal to the output signal (So), and detecting the WBS signal appearing in the received input signal (Si) via the feedback path 10. The detected WBS signal is then used to estimate the path loss of the feedback path 10. FIG. 2a illustrates a representative WBGC 8 in accordance with the present invention.

As shown in FIG. 2a, the WBGC 8 includes a wide-band signature generator 12 coupled to the signal path 6 for generating and adding the WBS signal to the output signal (So); a detector 14 coupled to the signal path 6 for detecting the WBS signal appearing in the input signal (Si); and a micro-controller 16 operating under suitable software control for controlling operation of the wideband signature generator 12 and detector 14, and for evaluating the system stability. The micro-controller 16 may also control gain of the signal path 6, for example by controlling a variable gain amplifier (VGA) 18 inserted in the signal path 6.

In accordance with the present invention, the WBS signal is a spread spectrum signal generated by modulating a baseband signal b(t) with a spreading code p(t) in a manner generally known in the art. Thus, in the illustrated embodiment, the signature signal generator comprises a baseband signal generator 20 for generating the baseband signal b(t); a wide-band signal spreader 22 for modulating the baseband signal p(t) using the spreading code p(t) output by a spreading code generator 24 to generate a modulated baseband signal a(t)=b(t)·p(t); and a mixer 26 for up-converting the modulated baseband signal a(t) to RF using a local oscillator signal 28. With this arrangement, the wide-band signature (WBS) signal may be represented by an equation of the form:
s(t)=a(t)·Cos(ωt) (Equ.4)
Where ω is the carrier frequency. The thus generated WBS signal can then be added to the output signal (So) by, for example, a conventional directional coupler 30 (see FIG. 1) inserted in the signal path 6. As is well known in the art, alternative methods may also be used to insert the WBS signal into the output signal (So). For example, a power combiner can be used for this purpose, if desired. In either case, the power level of the WMS signal is low enough that it appears as low level noise within the output signal So, and thus will not significantly interfere with communications.

The baseband signal b(t) can be a simple sinusoidal signal having a selected frequency and amplitude, if desired. However, more preferably, the baseband signal b(t) is provided as an n-bit Pseudo-random Number (PN) having a selected bandwidth R. This arrangement facilitates a high processing gain in the detector 14, which enables accurate detection of weak WBS signal components in the input signal Si, as will be described in greater detail below.

In general, any arbitrary spreading code p(t) may be used, such as, for example, an m-bit Pseudo-random Number (PN). However, the spreading code should preferably be selected such that each repeater has a unique spreading code, at least among repeaters operating with overlapping coverage areas. This has an advantage that the repeater can positively identify its own signature signal, and thus accurately manage stability, even when the input signal Si contains signature signals transmitted by other neighboring repeaters. The length (in bits) of the spreading code p(t) can be selected as desired to balance cost and performance (e.g. bandwidth, sensitivity, correlation speed, etc.). A spreading code length of m=7 bits has been found to be satisfactory for a variety of applications. The bandwidth R_{w} of the spreading code p(t) is preferably selected to encompass at least a portion of total bandwidth of the wide-band signal path. Thus for example, for typical North American cellular communications networks, a bandwidth of approximately 20 MHz can be used.

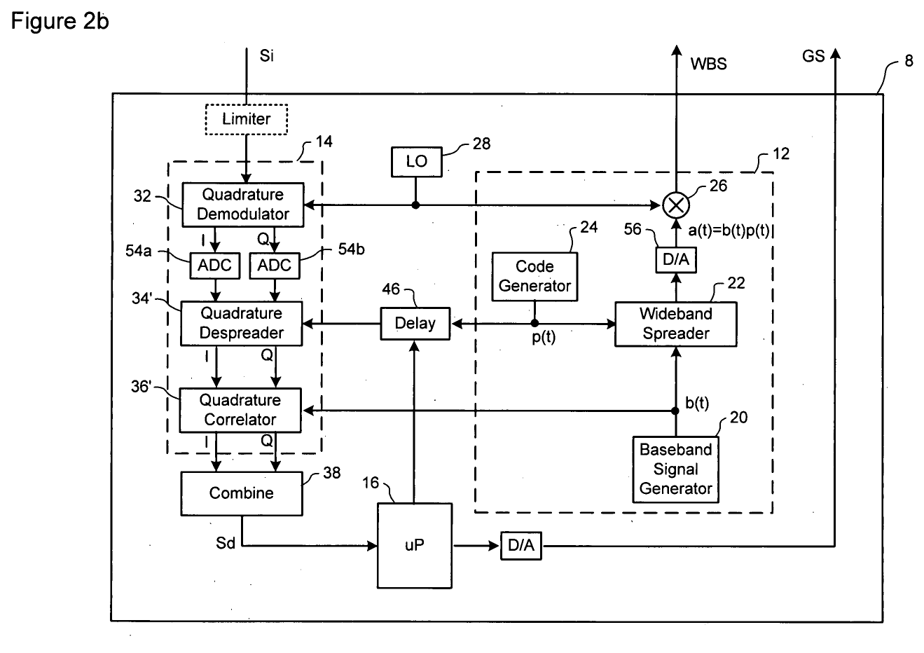

As will be appreciated, the spreading code generator 24 may be implemented in a variety of ways. For example, in cases where the spreading code p(t) is provided as an m-bit PN code, an m-stage linear feedback shift register of the type illustrated in FIG. 3 can be used. This arrangement has advantages of low cost and simple implementation. However, other known methods of generating the spreading code p(t) may be used, as desired. As is known in the art, the output of the shift register will be a periodic sequence having a repetition period of Tₒ=2^{m}−1. Given a unique starting value, the shift register will generate a corresponding unique sequence. Advantageously, up to 2^{m}−1 orthogonal initial values can be defined, which means that it is possible to assign a unique PN code to each one of 2^{m}−1 repeaters.

In order to avoid interference with other subscriber traffic, the level of the signature signal added to the output signal So is preferably kept at least 3 dB below the noise floor. For example, keeping the WBS signal level 6 dB lower than the noise floor guarantees less than a 1 dB increase in the noise floor due to the presence of the WBS signal. Detection of the resulting very weak WBS signal components in the input signal Si can be accomplished by suitably selecting the bandwidths R and R_{w} of the baseband signal b(t) and the spreading code p(t), respectively, so as to obtain a desired processing gain

$${G}_{p} = 10 log ( \frac{{R}_{w}}{R} )$$

in the detector 14. As is known in the art, suitable selection of the bandwidths R and R_{w} can provide a processing gain (Gₚ) of as much as 30 dB, or more, which provides sufficient margin to accurately detect the weak WBS signal components in the input signal Si.

Referring back to FIG. 2a, the detector 14 is configured to monitor the input signal Si, and detect the WBS signal appearing in the input signal Si via the feedback path 10. The detection result can then be used to estimate the feedback path loss, and thus the stability margin of the receiver.

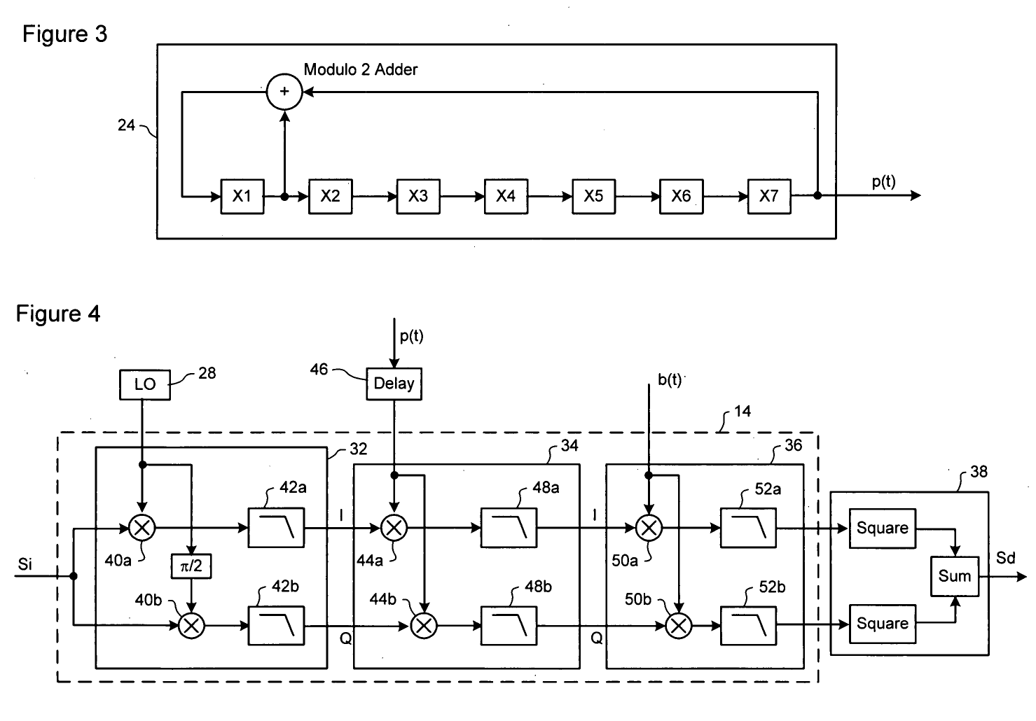

In the illustrated embodiment, the detector 14 comprises a quadrature demodulator 32 for down-converting the input signal Si to baseband, and outputting In-phase (I) and Quadrature(Q) signal components encompassing the WBS signal s(t); a quadrature despreader 34 for extracting the spreading code p(t) from the I and Q components; and a quadrature correlator 36 for extracting the baseband signal b(t). The residual I and Q components appearing at the correlator 36 output are then summed and added (at 38) to eliminate RF phase uncertainty, and yield a detection signal Sd that is directly proportion to the feedback path loss. These operations are described in greater detail below with reference to FIG. 4. If desired, an amplitude limiter 39 can be provided at the input of the detector 14 in order to suppress co-channel interference. This arrangement is particularly suited to embodiments in which the external received signal Se is discontinuous, such as, for example, an iDEN™ uplink signal or 1×EV-DO signal. In such cases, the discontinuous signal appears at the input of the detector 14 as co-channel interference to the WBS signal. The amplitude limiter 39 implements a soft limiting function on the input signal Si, which suppresses low level noise (including co-channel interference) and improves the SNR of the WBS signal.

As shown in FIG. 4, the quadrature demodulator 32 comprises a pair of parallel mixers 40a, 40b connected to receive the input signal Si. One mixer 40a combines the input signal Si with the local oscillator signal 28 to down-convert the input signal Si to a baseband In-phase (I) signal component. The other mixer 40b combines the input signal Si with a π/2 phase delayed version of the local oscillator signal 28, and thus down-converts the input signal Si to a baseband Quadrature (Q) signal component. For example, using the WBS signal of Eq.4 above, the corresponding received WBS signal component r(t) appearing in the input signal Si can be described using an equation of the form:

$$r ( t ) = \frac{G}{L} a ( t + η ) Cos ( ω ( t + η ) ) \qquad ( Equ . 5 )$$

Where G is the repeater gain, L is the path loss, and η (=δ+Δ) is the total “loop delay” experienced by the WBS signal through the repeater and feedback path 10 at the carrier frequency ω. Following demodulation, the corresponding I and Q signal components will have values of:

$$\begin{matrix}{r}_{I} ( t ) = \frac{1}{2} \frac{G}{L} a ( t + η ) Cos ( ω η ) & ( Equ . 6 a ) \\ And & \\ {r}_{Q} ( t ) = \frac{1}{2} \frac{G}{L} a ( t + η ) Sin ( ω η ) & ( Equ . 6 b )\end{matrix}$$

A pair of low pass filters 42a, 42b connected downstream of each mixer attenuate out-of-band noise in the I and Q signal components, so as to isolate the desired signal components (i.e. those corresponding to the WBS signal) from the total RF signal traffic of the input signal Si.

The quadrature despreader 34 comprises a pair of parallel multipliers 44a, 44b connected to receive the I and Q components output from the quadrature demodulator 32. Each multiplier 44 combines its respective signal component with a delayed version of the spreading code p(t). The magnitude of the delay 46 is preferably calculated to approximate the loop delay n of the receiver and feedback path 10. In cases where the feedback path delay A is small, the loop delay n will be dominated by the repeater, and thus the delay 46 can be estimated as the repeater path delay δ. If desired, the magnitude of the delay 46 can be adjusted by the micro-controller 16, in order to optimize system operation. Again, a pair of low pass filters 48a, 48b connected downstream of each mixer 44 can be used to attenuate out-of-band noise in the I and Q components, and thus isolate signal components corresponding to the baseband signal b(t). Continuing the above example, and noting that p²(t+η)=1, the I and Q signal components at the output of the quadrature despreader 34 will have values of:

$$\begin{matrix}{r}_{I} ( t ) = \frac{1}{2} \frac{G}{L} b ( t ) Cos ( ω η ) & ( Equ . 7 a ) \\ And & \\ {r}_{Q} ( t ) = \frac{1}{2} \frac{G}{L} b ( t ) Sin ( ω η ) & ( Equ . 7 b )\end{matrix}$$

The quadrature correlator 36 comprises a pair of parallel multipliers 50a, 50b connected to receive the I and Q components output from the quadrature despreader 34. Each multiplier 50 combines its respective signal component with the baseband signal b(t). Noting that b²(t)=1, this operation yields I and Q component values of:

$$\begin{matrix}{r}_{I} ( t ) = \frac{1}{2} \frac{G}{L} Cos ( ω η ) & ( Equ . 8 a ) \\ And & \\ {r}_{Q} ( t ) = \frac{1}{2} \frac{G}{L} Sin ( ω η ) & ( Equ . 8 b )\end{matrix}$$

Again, a pair of low pass filters 52a, 52b connected downstream of each mixer can be used to attenuate out-of-band noise.

The I and Q component values appearing at the output of the quadrature correlator 36 are then squared and summed (at 38) to eliminate RF phase uncertainties, which yield a detector output signal of the form:

$$sd = {r}_{I}^{2} ( t ) + {r}_{Q}^{2} ( t ) = \frac{1}{4} \frac{{G}^{2}}{{L}^{2}} \qquad ( Equ . 9 )$$

The logarithm of the detector output signal yields a detection result of:

$$d = 10 log ( Sd ) \\ = 10 log ( \frac{1}{4} \frac{{G}^{2}}{{L}^{2}} ) \\ = 10 log ( \frac{1}{4} {G}^{2} ) - 20 log ( L ) \qquad ( Equ . 10 )$$

which indicates that the detection result is directly proportional to the feedback path loss L in dB. Since the repeater gain G is known, the micro-controller 16 can readily sample the detector output signal Sd and determine the feedback path loss L (or, equivalently, the antenna isolation) as a direct indication of the repeater stability. Based on this information, the micro-controller 16 may implement any of a variety of stability management operations. For example, the micro-controller 16 may use one or more threshold values to determine whether or not the feedback path loss L is satisfactory. In the event that feedback path loss L is found to be too low, the micro-controller 16 may control the VGA 18 (see FIG. 1) to decrease the signal path gain G, and thereby ensure stability. Other-stability management functions may also be implemented, as desired.

FIG. 2b illustrates an alternative embodiment of the WBGC 8, in which IF signal processing within the detector 14 is performed digitally. In this case, I and Q signal components generated by the quadrature demodulator 32 are sampled by respective analog-to-digital converters (ADCs) 54a and 54b, which generate corresponding digital component signals. Downstream of the ADCs 54 conventional digital signal processing techniques are utilized to implement the quadrature despreader 34′ and quadrature correlator 36′ functions.

Additionally, generation of the WBS signal is also performed digitally, with conventional digital signal processing techniques being used to implement the baseband signal generator 20 and wide-band signal spreader 22, and mixer 26. A Digital-to-Analog (D/A) converter 56 inserted between the wide-band signal spreader 22 and mixer 26 converts the digital WBS signal into an equivalent analog signal for transmission.

The embodiment(s) of the invention described above is(are) intended to be exemplary only. The scope of the invention is therefore intended to be limited solely by the scope of the appended claims.

I claim:

1. A method of monitoring stability of an on-frequency repeater, the method comprising steps of:
generating a wide-band signature (WBS) signal associated with the repeater;
inserting the WBS signal into an output RF signal transmitted by the repeater;
extracting signal components corresponding to the WBS signal in an input RF signal received by the repeater; and
estimating a feedback path loss L using the isolated signal components.

2. A method as claimed in claim 1, wherein the step of generating the wide-band signature (WBS) signal comprises steps of:
generating a baseband signal b(t);
modulating the baseband signal using a predetermined spreading code p(t); and
modulating an RF carrier signal using the modulated baseband signal a(t).

3. A method as claimed in claim 2, wherein the baseband signal b(t) comprises any one:
of a sinusoidal signal; and
a Psuedo-random Number (PN).

4. A method as claimed in claim 2, wherein a bandwidth Rw of the spreading code p(t) is selected based on a bandwidth of the output RF signal.

5. A method as claimed in claim 4, wherein a bandwidth R of the baseband signal b(t) is selected based on the bandwidth Rw of the spreading code p(t) and a desired processor gain Gp.

6. A method as claimed in claim 2, wherein the spreading code p(t) is a Psuedo-random Number (PN).

7. A method as claimed in claim 2, wherein the spreading code p(t) is selected from a among a set of orthogonal spreading codes.

8. A method as claimed in claim 7, wherein a respective different spreading code is selected for each one of a set of repeaters having overlapping coverage areas.

9. A method as claimed in claim 1, wherein the step of inserting the WBS signal into the output RF signal comprises any one or more of:
adding the WBS signal to the output RF signal using a coupler; and
adding the WBS signal to the output RF signal using a power combiner.

10. A method as claimed in claim 9, wherein a power level of WBS signal is at least 3 dB below a noise floor of the output RF signal

11. A method as claimed in claim 2, wherein the step of extracting signal components corresponding to the WBS signal comprises steps of:
down-converting the input RF signal to generate a pair of in-phase (I) and quadrature (Q) signal components encompassing the modulated baseband signal a(t);
despreading each signal component using a delayed version of the spreading code p(t+η) to isolate corresponding I and Q signal components associated with the WBS signal; and
correlating the isolated I and Q signal components with the baseband signal b(t) to generate corresponding output signal components indicative of a power level of the feedback path loss L.

12. A method as claimed in claim 11, wherein the step of estimating the feedback path loss L comprises a step of:
computing a sum of squares of the output quadrature signal components; and
subtracting an effect of repeater gain G from the sum of squares result.

13. A system for monitoring stability of an on-frequency repeater, the system comprising:
wide-band signature (WBS) signal generator for generating a respective WBS signal associated with the repeater;
means for inserting the WBS signal into an output RF signal transmitted by the repeater;
wide-band signature (WBS) signal detector for isolating signal components corresponding to the WBS signal in an input RF signal received by the repeater; and
a processor for estimating a feedback path loss L using the isolated signal components.

14. A system as claimed in claim 13, wherein the wide-band signature (WBS) signal generator comprises:
a baseband signal generator for generating a baseband signal b(t);
a signal spreader for modulating the baseband signal using a predetermined spreading code p(t)to generate a modulated baseband signal a(t); and
a mixer for modulating an RF carrier signal using the modulated baseband signal a(t).

15. A system as claimed in claim 14, wherein the baseband signal b(t) comprises any one:
of a sinusoidal signal; and
a Psuedo-random Number (PN).

16. A system as claimed in claim 14, wherein a bandwidth Rw of the spreading code p(t) is selected based on a bandwidth of the output RF signal.

17. A system as claimed in claim 16, wherein a bandwidth R of the baseband signal b(t) is selected based on the bandwidth Rw of the spreading code p(t) and a desired processor gain Gp.

18. A system as claimed in claim 14, wherein the spreading code p(t) is a Psuedo-random Number (PN).

19. A system as claimed in claim 14, wherein the spreading code p(t) is selected from a among a set of orthogonal spreading codes.

20. A system as claimed in claim 19, wherein a respective different spreading code is selected for each one of a set of repeaters having overlapping coverage areas.

21. A system as claimed in claim 13, wherein the means for inserting the WBS signal into the output RF signal comprises any one or more of a coupler and a power combiner.

22. A system as claimed in claim 21, wherein a power level of WBS signal is at least 3 dB below a noise floor of the output RF signal

23. A system as claimed in claim 14, wherein the wide-band signature (WBS) signal detector comprises:
a quadrature mixer for down-converting the input RF signal to generate a pair of In-phase (I) and Quadrature (Q) signal components encompassing the modulated-baseband signal a(t);
a quadrature despreader for dispreading each signal component using a delayed version of the spreading code p(t+η) to isolate corresponding I and Q signal components associated with the WBS signal; and
a quadrature correlator for correlating the isolated I and Q signal components with the baseband signal b(t) to generate corresponding output signal components indicative of feedback path loss L.

24. A system as claimed in claim 23, wherein the processor comprises:
means for computing a sum of squares of the output quadrature signal components; and
means for subtracting an effect of repeater gain G from the sum of squares result.
